(19) United States
(12) Patent Application Publication
(10) Pub. No.: US 2015/0205456 A1
(43) Pub. Date: Jul. 23, 2015

(54) Method and Device for Processing Application Shortcut

(71) Applicant: ZTE CORPORATION, Shenzhen City, Guangdong Province (CN)

(72) Inventors: Yunlei Ji, Shenzhen (CN); Mingsheng Yan, Shenzhen (CN); Juan Li, Shenzhen (CN)

(21) Appl. No.: 14/421,495

(22) PCT Filed: Jun. 28, 2013
(86) PCT No.: PCT/CN2013/078448

§ 371 Date: Feb. 13, 2015

(30) Foreign Application Priority Data
Aug. 15, 2012 (CN) 201210290506.1

(51) Int. Cl. G06F 3/0482; G06F 9/44; G06F 3/0487; G06F 3/0484

(52) U.S. Cl. CPC G06F 3/0482; G06F 3/0484; G06F 9/4443; G06F 3/0487

(57) ABSTRACT

A method and device for processing a shortcut of an application are disclosed. The method includes: establishing a shortcut bar in a notification bar of a terminal; and setting the shortcut of the application in the shortcut bar. Through the embodiments of the present document, a problem that the user experience comfort level is low in the existing application shortcut setting is solved, and the user experience is improved.

### TECHNICAL FIELD

The present invention relates to the field of communication, and specifically, to a method and device for processing a shortcut of an application.

### BACKGROUND OF THE RELATED ART

With the continuous upgrading of mobile terminals (e.g. a mobile phone), smart terminals (e.g. a smartphone) have been extremely popularized, and functions of the terminals are also more and more powerful. For example, a user can freely install various applications, and it has been a very common situation to install dozens of applications in the terminals.

Moreover, ways for setting shortcuts of all applications in the current mobile terminals (such as the mobile phone) are almost the same, either all the shortcuts are set into a row at the bottom of the homepage of the desktop, or the shortcuts are set by using the entire desktop, that is, shortcuts of the frequently-used applications are tiled on the desktop, or they are tiled on the desktop by page and so on. However, whatever the above ways for setting are adopted, it will exert certain influence on the desktop appearance, that is, shortcut icons of the applications are covered much on the background picture of the desktop, so that only a certain area of the background picture elaborately selected and set by the user can be previewed. In addition, if the shortcuts of the application are set in this way, when the user performs handover between the applications, he/she must firstly quit an ongoing application and return to the desktop to select a shortcut of an application to run and then enter the application. Obviously, such operation steps are slightly complicated, thus convenience and efficiency of the shortcuts are not reflected.

With respect to the problem that the user experience comfort level is low on the existing application shortcut set in the related art, no effective solution has been proposed at present.

### SUMMARY OF THE INVENTION

The embodiments of the present invention provide a method and device for processing a shortcut of an application, to overcome a problem that the user experience comfort level is low in the existing application shortcut setting.

In order to solve the above problem, according to one aspect of the embodiment of the present invention, a method for processing a shortcut of an application is provided, the method comprises: establishing a shortcut bar in a notification bar of a terminal; and setting the shortcut of the application in the shortcut bar.

Alternatively, the step of setting the shortcut of the application in the shortcut bar comprises: acquiring an icon of the application or a text description of the application; and displaying the icon of the application or the text description of the application in the shortcut bar, wherein, a click action to the icon is registered as an entry of the application.

Alternatively, the step of acquiring an icon of the application or a text description of the application comprises: receiving an operation for setting the shortcut of the application to the notification bar by a user; and acquiring the icon of the application or the text description of the application corresponding to the shortcut.

Alternatively, before the step of establishing a shortcut bar in a notification bar of a terminal, the method further comprises: determining a location of the shortcut bar in the notification bar according to a priority of the shortcut of the application.

Alternatively, the method further comprises: when at least one of the following cases occurs, canceling the shortcut of the application in the notification bar: closing a function of setting the shortcut of the application in the notification bar; deleting the shortcut of the application; and uninstalling the application corresponding to the shortcut of the application.

According to another aspect of the embodiment of the present invention, a device for processing a shortcut of an application is further provided, the device comprises: an establishment module, configured to: establish a shortcut bar in a notification bar of a terminal; and a setting module, configured to: set the shortcut of the application in the shortcut bar.

Alternatively, the setting module comprises: an acquisition module, configured to: acquire an icon of the application or a text description of the application; and a display module, configured to: display the icon of the application or the text description of the application in the shortcut bar, wherein, a click action to the icon is registered as an entry of the application.

Alternatively, the acquisition module is further configured to: receive an operation for adding the shortcut of the application to the notification bar by a user; and acquire the icon of the application or the text description of the application corresponding to the shortcut.

Alternatively, the establishment module further comprises: a priority storage module, configured to: determine a location of the shortcut bar in the notification bar according to a priority of the shortcut.

Alternatively, cases of canceling the shortcut of the application in the notification bar comprise at least one of the following: closing a function of setting the shortcut of the application in the notification bar; deleting the shortcut of the application; and uninstalling the application corresponding to the shortcut of the application.

Through the embodiments of the present invention, with the method of establishing the shortcut bar in the notification bar of the terminal and setting the shortcut of the application in the established shortcut bar, a problem that setting the shortcut of the application on the desktop affects a desktop appearance and an application handover process is complicated is solved, thereby achieving an effect of enhancing the user experience.

### BRIEF DESCRIPTION OF DRAWINGS

FIG. 1 is a flow chart of a method for processing a shortcut of an application according to the embodiment of the present invention.

FIG. 2 is a block diagram of a structure of a device for processing a shortcut of an application according to the embodiment of the present invention.

FIG. 3 is a flow chart of a method for setting a shortcut of an application according to the preferred embodiment of the present invention.

FIG. 4 is a flow chart of a method for drawing an application according to the preferred embodiment of the present invention.

FIG. 5 is a flow chart of a method for canceling a shortcut of an application according to the preferred embodiment of the present invention.

FIG. 6 is a schematic diagram 1 of layout when a priority of the shortcut of the application is set as high according to the preferred embodiment of the present invention.

FIG. 7 is a schematic diagram 2 of layout when a priority of the shortcut of the application is set as high according to the preferred embodiment of the present invention.

FIG. 8 is a schematic diagram 3 of layout when a priority of the shortcut of the application is set as high according to the preferred embodiment of the present invention.

FIG. 9 is a schematic diagram 1 of layout when a priority of the shortcut of the application is set as low according to the preferred embodiment of the present invention.

FIG. 10 is a schematic diagram 2 of layout when a priority of the shortcut of the application is set as low according to the preferred embodiment of the present invention.

FIG. 11 is a schematic diagram 3 of layout when a priority of the shortcut of the application is set as low according to the preferred embodiment of the present invention.

FIG. 12 is a block diagram of a structure of an establishment module according to the preferred embodiment of the present invention.

### PREFERRED EMBODIMENTS OF THE INVENTION

The embodiments of the present invention will be described in detail in combination with the accompanying drawings below. It should be noted that the embodiments in the present invention and the characteristics in the embodiments can be optionally combined with each other in the condition of no conflict.

The shortcuts of the existing mainstream terminals are mainly set on the desktop, so that a desktop background elaborately selected by a user cannot be completely displayed, moreover, when a handover is performed between applications, the user must firstly quit an ongoing application, and other applications can be started, though the user can implement a complete display of the desktop background by canceling the shortcuts, a disadvantage by doing so is that the user cannot rapidly enter an application which the user often accesses, and it has certain influence on both usage and appearance. Even though a plurality of on-off shortcuts (such as WIFI, contextual model and screen luminance and so on) are fixedly integrated in a pull-down menu of the existing terminals, with regard to other applications frequently used by the user, the user still cannot switch the applications in the terminal at will.

In the embodiments of the present invention, the shortcuts of the applications are set in notification bars (e.g. a pull-down menu and so on) of the terminal, wherein, the pull-down menu is a window displayed after sliding down from the top of the screen, and a notification bar of the terminal is a sliding window that can be displayed on a display screen of the terminal and can be hidden. Through such setting, setting the shortcuts on the desktop is avoided, moreover, it is unnecessary to quit an ongoing application when a handover is performed between the applications, it is to directly slide the pull-down menu and click a shortcut icon in the notification bar, thus a corresponding application can be started, thereby improving the user experience.

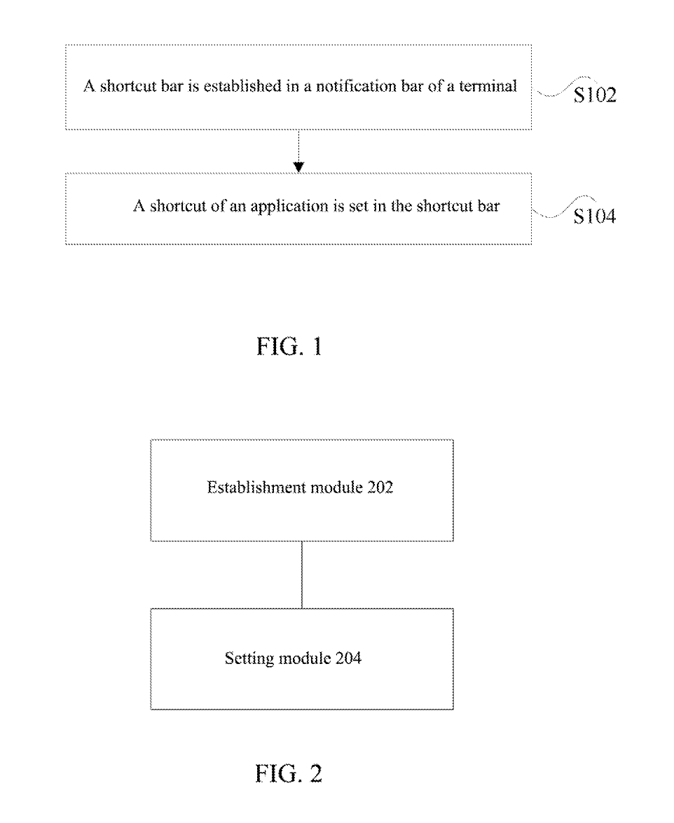

The embodiment of the present invention provides a method for processing a shortcut of an application, FIG. 1 is a flow chart of the method for processing the shortcut of the application according to the embodiment of the present invention, and as shown in FIG. 1, the method includes the following steps S102 to S104.

In step S102, a shortcut bar is established in a notification bar of a terminal.

In step S104, the terminal sets the shortcut of the application in the shortcut bar.

Through the above steps, the shortcut bar (i.e. View) is established in the notification bar of the terminal, according to user needs, the shortcut of the application is set in the shortcut bar, therefore, the user can be unnecessary to quit an ongoing application when starting a new application, the application can be directly started by sliding the notification bar and clicking the application required to be started, thereby enabling the user to switch the applications at will, moreover, through such setting, the shortcut of the application is not set on the desktop any more, thereby guaranteeing an appearance of the desktop, and achieving an effect of enhancing the user experience.

Alternatively, the step of the terminal setting the shortcut of the application in the shortcut bar includes: the terminal acquiring an icon of the application or a text description of the application; and the terminal displaying the icon of the application or the text description of the application in the shortcut bar, wherein, a click action to the icon is registered as an entry of the application.

Alternatively, the step of the terminal acquiring an icon of the application or a text description of the application includes: the terminal receiving an operation of a user setting the shortcut of the application to the notification bar; and the terminal acquiring the icon of the application or the text description of the application corresponding to the shortcut.

Alternatively, before the step of establishing the shortcut bar in the notification bar of the terminal, it also includes: the terminal determining a location of the shortcut bar in the notification bar according to a priority of the shortcut of the application. For example, when the user sets a priority of a shortcut A of the application as high, if other contents (e.g. a notification message) exist in the notification bar of the terminal, the shortcut A of this application is established at the top of the notification bar since the priority of the shortcut A of the application is high, that is, it is established above the notification message; for another example, when the user sets a priority of a shortcut B of the application as low, if other contents (e.g. a notification message) exist in the notification bar of the terminal, the shortcut B of the application is established below the notification message since the priority of the shortcut B of the application is low.

Alternatively, the method also includes: when at least one of the following cases occurs, the terminal canceling the shortcut of the application in the notification bar: closing a function of setting the shortcut of the application in the notification bar; deleting the shortcut of the application; and uninstalling the application corresponding to the shortcut of the application.

In the embodiment, a device for processing a shortcut of an application is also provided, the device is used for implementing the above example and its alternative embodiments, contents which have been described will not be repeated, and it is to describe all modules involved in the device below. For example, a term “module” used below can be a combination of software and/or hardware for implementing preset functions. Though the system and method described in the following embodiments are preferentially implemented by software, an implementation by hardware or a combination of software and hardware is also possible and conceived.

FIG. 2 is a block diagram of a structure of the device for processing the shortcut of the application according to the embodiment of the present invention, and as shown in FIG. 2, the device includes: an establishment module 202 and a setting module 204. All modules of the device and functions of the modules will be described below.

The establishment module 202 is configured to: establish a shortcut bar in a notification bar of a terminal.

The setting module 204, connected to the establishment module 202, is configured to: set the shortcut of the application in the shortcut bar.

Alternatively, the setting module 204 also includes: an acquisition module, configured to: acquire an icon of the application or a text description of the application; and a display module, configured to: display the icon of the application or the text description of the application in the shortcut bar, wherein, a click action to the icon is registered as an entry of the application.

Alternatively, the acquisition module is also configured to: receive an operation for adding the shortcut of the application to the notification bar by a user; and acquire the icon of the application or the text description of the application corresponding to the shortcut.

Alternatively, the establishment module also includes: a priority storage module, configured to: determine a location of the shortcut bar in the notification bar according to a priority of the shortcut.

Alternatively, when at least one of the following cases occurs, the terminal cancels the shortcut of the application in the notification bar: closing a function of setting the shortcut of the application in the notification bar; deleting the shortcut of the application; and uninstalling the application corresponding to the shortcut of the application.

Descriptions will be made in combination with a preferred embodiment below, the preferred embodiment combines the above example and its alternative embodiments, in the preferred embodiment, the technical problem required to be solved is to set the shortcut of the application in the notification bar (with a pull-down menu as an example) of the terminal, so that the user can custom a shortcut required to be set and use the shortcut more effectively, wherein the pull-down menu is a window displayed after sliding down from the top of the screen.

In the embodiment, an application shortcut key in the pull-down menu is set through a “set” module of the terminal, a display mode of shortcuts can be one row or more than one row, but it is not limited to such display mode. After a shortcut display is started in the setting module, the terminal establishes a shortcut bar (View) in the pull-down menu for storing shortcut icons. When a shortcut of a corresponding application is set, a build-in icon of the application is acquired via an interface and displayed in the established View, meanwhile a click action to the icon is registered as an entry of the corresponding application, and then the corresponding application can be started by clicking the shortcut icon in the pull-down menu.

In the embodiment, for the pull-down menu shortcut key display, it can set whether to display the shortcut in the pull-down menu through the “set” module of the terminal. When the display is started, the pull-down menu displays a series of shortcuts set by the user by way of controls or chart drawing, and when the display is closed, it makes the shortcuts in the pull-down menu not displayed by destroying, hiding controls or redrawing and refreshing, and space of the pull-down menu is not occupied.

In the embodiment, when the pull-down menu shortcut key setting is that the pull-down menu shortcut key display is set to start in the terminal, the user can set the applications displayed in the pull-down menu. In this step, the “set” module firstly retrieves applications installed on the terminal and displays the installed applications, and the user can select applications required to be displayed in the pull-down menu according to actual requirements.

In the embodiment, when it is to set the shortcut of the application in the shortcut bar, after receiving a message that the user sets to add the shortcut in the notification bar, firstly an application icon thereof and a start interface are acquired from an application “packet” (here referred to the set of a series of files of the application), then a message is sent or an interface of the notification bar is directly called, and the notification bar of the terminal performs locating the icon and binding a boot entry. It should be noted that all the current applications of the terminal have resource files and boot interfaces, and the purpose thereof is to make a design developer design and develop the applications. An application shortcut set by the user can be seen in the pull-down menu after setting is successful, and it can enter the corresponding application by clicking the icon.

Certainly, setting the shortcut of the application is not limited to the above setting mode, for example, a simpler mode can be that the user directly dragging the application icon into the pull-down menu. An operation of the user dragging the application icon into the pull-down menu can be that, when the user enters a shortcut location arrangement (e.g. an enter mode can be: long pressing the application icon, and the system receiving a message similar to long_press), the user can drag the icon to an area of the notification bar, and when the system detects that 1/n (n can be determined by a manufacturer) of the icon enters the area of the notification bar, it starts a flow of placing the shortcut into the notification bar, and the picture, some or all of the texts or icons of the notification bar can be changed by way of calling the interface of the system, so as to enter an explicit remind of the flow of placing the current shortcut into the notification bar, the user hands off at this point, the system performs, after receiving a message similar to mouse_up, application binding of the notification bar, and the flow of the binding is the same as the user manually setting the setting module described above. If it is to restore an appearance of the notification bar, the user can drag the icon out of the critical area without putting hands off, and thus the appearance of the notification bar can be restored by calling the interface of the system.

In the embodiment, the user canceling the shortcut in the pull-down menu, and when the shortcut is canceled in the pull-down menu, a canceling flow thereof is inverted to the corresponding setting flow, and canceling modes thereof also can be various means:

(1) Canceling by setting in the setting module: after receiving a cancel message, the terminal starts an application shortcut uninstall flow, deletes corresponding data from a data filed (e.g., a form of the data filed can be a list, an array and a database and so on) of the application shortcut of the notification bar, performs unbinding, and when the user pulls down the pull-down menu of the terminal again, performs display refresh of the data, at this point, since there are no data related to the uninstalled application in the data, the shortcut of the application will not be displayed any more.

(2) Canceling by means of dragging to delete: the user can pull down the pull-down menu and drag an application icon required to be canceled to a specified deletion area, thus the system starts a deletion flow after receiving a deletion instruction, deletes corresponding data from a data filed (e.g., a form of the data filed can be a list, an array and a database and so on) of the application shortcut of the notification bar, and performs unbinding, at this point, since there are no data related to the uninstalled application in the data, the shortcut of the application will not be displayed any more.

(3) Canceling by means of directly deleting: the user can pull down the pull-down menu, directly display “to delete the icon” on the shortcut icon, receive a click message to enter a deletion flow, delete corresponding data from a data filed (e.g., a form of the data filed may be a list, an array and a database and so on) of the application shortcut of the notification bar, perform unbinding, and promptly perform redrawing on a shortcut window according to new data. At this point, since there are no data related to the uninstalled application in the data, the shortcut of the application will not be displayed any more.

(4) Canceling by means of deleting or uninstalling applications: after the user deletes/uninstalls an application on which a shortcut has been set, the notification bar will also receive a corresponding message (similar to an app_uninstall message), and it is also required to start an application shortcut uninstall flow at this point. A download flow is the same as above, which will not be repeated here.

In the embodiment, display patterns of the shortcuts of the applications in the pull-down menu can be varied, after a shortcut of the pull-down menu is set, the set shortcut is displayed in the pull-down menu, and the display modes can be varied. For example, display by single row: when the number of icons exceeds one row, the user can switch via a sliding operation to traverse shortcut icons. For another example, display by multi-row, when application shortcuts added by the user exceed a range that can be displayed by one row, the icons will be switched to the second row to be displayed, and so on. The display of the shortcuts is not limited to the scopes listed above, and it also can be displayed by other similar means.

In the embodiment, the display of the shortcut of the application in the pull-down menu can be determined according to a priority of the shortcut of the application: when the priority is set as high, the shortcut is displayed at the top of the pull-down menu. When the priority is set as low, the shortcut is displayed behind a notification message of the pull-down menu.

Through the above example and its alternative embodiments, by setting the shortcut of the application in the pull-down menu, when the user performs handover between the applications, it is unnecessary to firstly quit an ongoing application and then enter another application, and more conveniently, when a certain application is running, if the user wishes to switch to an application on which a shortcut has been set by the user, it is only required to pull down the pull-down menu and select a corresponding application to enter the application, thereby achieving a “convenience” effect of the shortcut.

Descriptions will be made in combination with a preferred embodiment below, the preferred embodiment combines the above example and its alternative embodiments, in the preferred embodiment, by taking the pull-down menu in the notification bar as an example, the method for processing the shortcut of the application will be described.

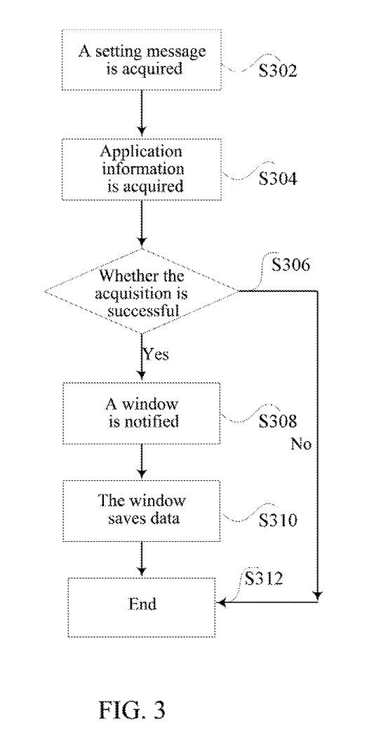

FIG. 3 is a flow chart of a method for setting a shortcut of an application according to the preferred embodiment of the present invention, and as shown in FIG. 3, the method includes the following steps S302 and S312.

In step S302, a setting message is acquired. When a user sets the shortcut through a UI interface, a setting flow is started, and a system acquires the setting message at this point and reports the message.

In step S304, an application message is acquired. When the reported message is received, the system performs acquisition of information of an application on which a shortcut is set.

In step S306, it is to judge whether the acquisition is successful, if the acquisition is failed, step S312 is executed; and if the acquisition is successful, step S308 is executed.

In step S308, a window is notified. After the set application information is acquired, the window acquires notification information.

In step S310, the window saves data. The application information is saved for drawing and display of the shortcut.

In step S312, the setting flow ends.

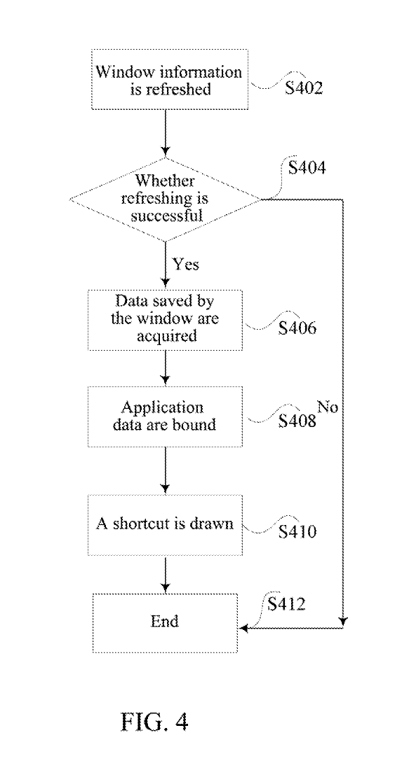

After the setting flow ends and the window acquires the application set notification message, it will enter a drawing flow. FIG. 4 is a flow chart of a method for drawing an application according to the preferred embodiment of the present invention, and as shown in FIG. 4, the method includes the following steps S402 and S412.

In step S402, window information is refreshed, and display of an existed shortcut is emptied.

In step S404, it is judged whether window refreshing is successful, if the window refreshing is failed, step S412 is executed, and the flow ends; and if the window refreshing is successful, step S406 is executed.

In step S406, the data saved by the window are acquired. After the refreshing is successful, a drawing module performs acquisition of the application information saved by the window in the step S310, and saves the acquired application information.

In step S408, application data are bound. For example, the starting interface is bound and so on.

In step S410, a shortcut is drawn. According to the acquired application information and the bound application data, the shortcut is drawn.

In step S412, the drawing flow ends.

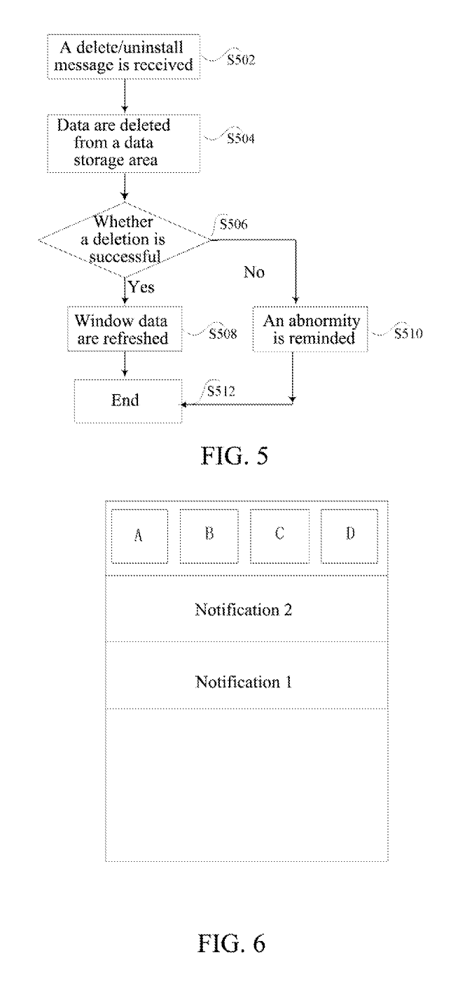

FIG. 5 is a flow chart of a method for canceling a shortcut of an application according to the preferred embodiment of the present invention, and as shown in FIG. 5, the method includes the following steps S502 and S512.

In step S502, a delete/uninstall message is received. When an application is uninstalled or a shortcut is deleted, a system receives an uninstall/delete message.

In step S504, data are deleted from a data storage area. After the message is received, application information saved in the data storage area are deleted and updated.

In step S506, it is judged whether a deletion is successful, if the deletion is failed, step S510 is executed, and if the deletion is successful, step S508 is executed.

In step S508, window data are refreshed. The window data are refreshed for starting a redrawing flow.

In step S510, an abnormity is reminded. After the deletion is failed, the abnormity is reminded.

In step S512, the canceling flow ends.

In the following preferred embodiments, a layout of the shortcuts of the applications will be described. Descriptions will be made by taking a layout according priorities of the shortcuts as an example.

1. When a priority of a shortcut of an application is set as high, a layout for the shortcut of the application can be divided into the following cases.

FIG. 6 is a schematic diagram 1 of layout when a priority of the shortcut of the application is set as high according to the preferred embodiment of the present invention, as shown in FIG. 6, the shortcut is set when there is a notification message in a pull-down menu, and since the display priority of the shortcut is high, the shortcut bar is drawn at the top of the pull-down menu.

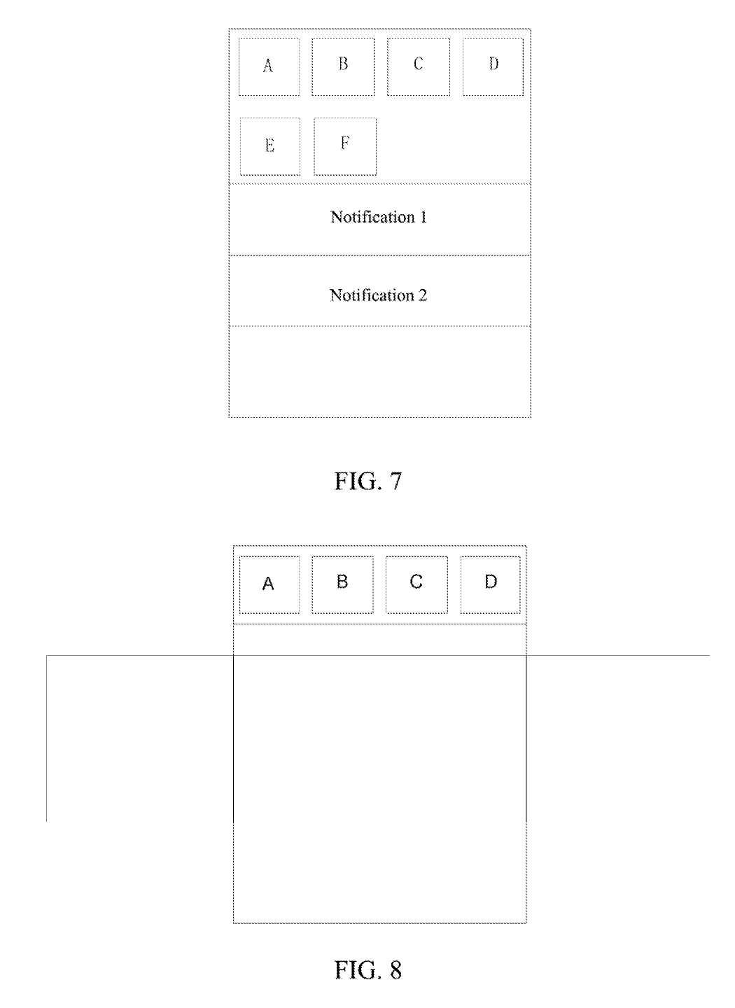

FIG. 7 is a schematic diagram 2 of layout when a priority of the shortcut of the application is set as high according to the preferred embodiment of the present invention, as shown in FIG. 7, the shortcut is set when there is a notification message in a pull-down menu, since a display priority of the shortcut is high, the shortcut bar is drawn at the top of the pull-down menu. When the number of the set shortcuts exceeds a range that can be displayed by one screen, the shortcut layout is extended, the extended rows are used for storing shortcuts exceeding the range, such as E and F in FIG. 7. FIG. 7 is a layout interface of displaying shortcuts by multiple TOWS.

FIG. 8 is a schematic diagram 3 of layout when a priority of the shortcut of the application is set as high according to the preferred embodiment of the present invention, as shown in FIG. 8, when there is no notification message in the pull-down menu, that is, the shortcut is set when the pull-down menu is empty, the shortcut is directly established at the top of the pull-down menu, and when there is a notification message, the notification message is established below a shortcut key, and the layout display is identical with FIG. 6 at this point.

2. When a priority of a shortcut of an application is set as low, a layout for the shortcut of the application can be divided into the following cases.

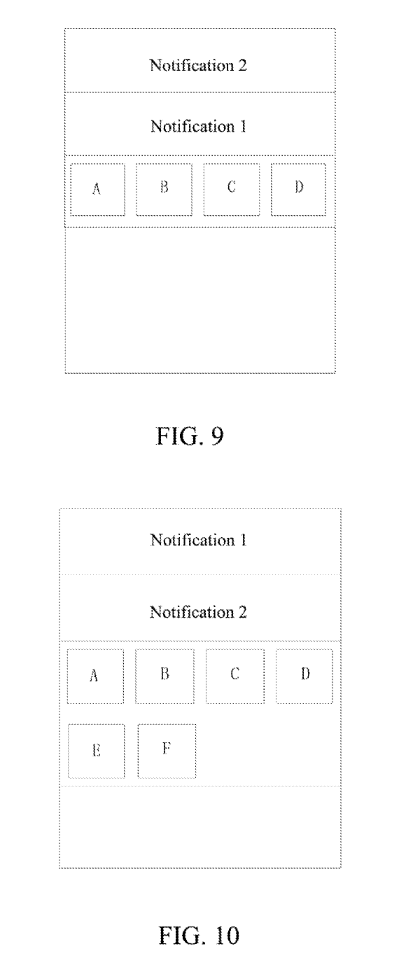

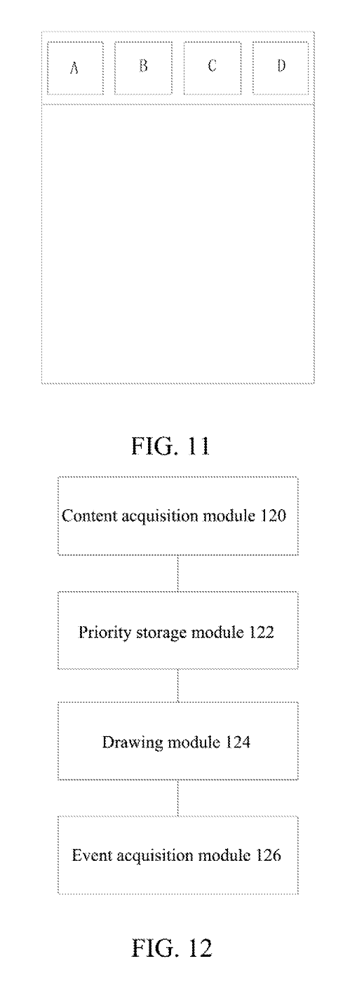

FIG. 9 is a schematic diagram 1 of layout when a priority of the shortcut of the application is set as low according to the preferred embodiment of the present invention, as shown in FIG. 9, the shortcut is set when there is a notification message in a pull-down menu, and since the display priority of the shortcut is low, a shortcut bar is drawn behind other notification messages in the pull-down menu, as shown in FIG. 9. After the notification message is read, the notification message will not be displayed in the pull-down menu any more, and the shortcut will be displayed at the top of the pull-down menu at this point, as shown in FIG. 11. When the notification messages are not all read, the shortcut bar will be still displayed behind unread notification messages.

FIG. 10 is a schematic diagram 2 of layout when a priority of the shortcut of the application is set as low according to the preferred embodiment of the present invention, as shown in FIG. 10, the shortcut is set when there is a notification message in a pull-down menu, since the display priority of the shortcut is low, a shortcut bar is drawn behind other notification messages in the pull-down menu, when the number of the set shortcuts exceeds a range that can be displayed by one screen, the shortcut layout is extended, the extended rows are used for storing shortcuts exceeding the range, such as E and F in FIG. 10. FIG. 10 is a layout interface of displaying shortcuts by multiple rows.

FIG. 11 is a schematic diagram 3 of layout when a priority of the shortcut of the application is set as low according to the preferred embodiment of the present invention, as shown in FIG. 11, when there is no notification message in a pull-down menu, that is, a shortcut is set when the pull-down menu is empty, the shortcut is directly established at the top of the pull-down menu, as shown in FIG. 11, and when there is a notification message, since a display priority of the shortcut is low, the notification message will be displayed at the bottom of the pull-down menu, the shortcut bar is displayed behind the notification message, and the layout display is identical with FIG. 9 at this point.

FIG. 12 is a block diagram of a structure of an establishment module according to the preferred embodiment of the present invention, and as shown in FIG. 12, the module consists of the following modules: a content acquisition module 120, a priority storage module 122, an event acquisition module 124 and a drawing module 126.

When the shortcut is set, the content acquisition module 120 will perform acquisition of contents contained in the pull-down menu currently, so as to obtain heights (H1, H2 . . . ) of all the contents, which are used in drawing the shortcuts.

After the user sets the display priority of the shortcut, the priority storage module 122 will store the priority.

Then the drawing module 126 will run. The drawing module 126 contains two parts of functions: a. image drawing function; b. shortcut counting function. When drawing a shortcut bar, the image drawing function a firstly performs acquisition of a priority in the priority storage module 122, and judges a drawing mode. When the priority is high, it is to directly perform drawing at the top of the pull-down menu. When the priority is low, heights of all the contents in the content acquisition module will be acquired and then drawn, a drawing start position is a screen coordinate (0, H1+H2+ . . . ). The shortcut counting function b is to implement an automatic extension of the shortcut bar, it is assumed that n icons can be maximally displayed by one row of the shortcut bar, and the number of icons is set as m. A counter firstly acquires m and then compares m and n, then the shortcut bar is drawn to have [(m−1)/n]+1 rows, particularly, when m=0, drawing will not be performed.

After the shortcut is set, the event acquisition module 124 will take effect, the event is that an operation is performed on other bars except the shortcut bar in the pull-down menu (e.g., the notification massage is read). When an event occurs, the event acquisition module 124 acquires the event, and notifies the content acquisition module 120 to perform reacquisition of the contents, and the shortcut bar is redrawn through all the modules.

Through the above examples and alternative embodiments thereof, the shortcut of the application is set in the notification bar of the display screen of the terminal, the user can enter applications more conveniently and implement a fast handover between the applications, by setting the shortcut of the application in the notification bar (e.g. a pull-down menu and so on) of the terminal, setting the shortcut on the desktop is avoided, moreover, the user is unnecessary to quit an ongoing application when performing handover between the applications, but directly slides the notification bar of the terminal, and clicks a shortcut icon to start a corresponding application, which achieves a purpose that the user switches the applications in the terminal at will, thereby improving the user experience.

The ordinary person skilled in the art can understand that all or part of the steps in the above method can be completed by a program instructing related hardware, and the program can be stored in a computer readable memory medium, such as a read-only memory, disk or optical disk and so on. Alternatively, all or part of the steps of the above embodiments also can be implemented by using one or multiple integrated circuits. Correspondingly, each module/unit in the above examples can be implemented in a form of hardware, and also can be implemented in a form of software function module. The embodiment of the present invention is not limited to any combination of hardware and software in a specific form.

The above embodiments are only used to describe the technical scheme of the present invention, which does not limit the technical scheme of the present invention. The present invention is just described in detail with reference to the preferred embodiments. The ordinary person skilled in the art should understand that, with regard to the technical scheme of the embodiments of the present invention, modifications or equivalent substitutions can be made without departing from the spirit and scope of the technical scheme of the embodiments of the present invention, and all these modifications and equivalent substitutions should be covered within the scope of the claims of the present invention.

### INDUSTRIAL APPLICABILITY

Through the embodiments of the present invention, with the method of establishing the shortcut bar in the notification bar of the terminal and setting the shortcut of the application in the established shortcut bar, a problem that setting the shortcut of the application on the desktop affects a desktop appearance and an application handover process is complicated is solved, thereby achieving an effect of enhancing the user experience.

What is claimed is:

1. A method for processing a shortcut of an application, comprising:
establishing a shortcut bar in a notification bar of a terminal; and
setting the shortcut of the application in the shortcut bar.

2. The method according to claim 1, wherein, the step of setting the shortcut of the application in the shortcut bar comprises:
acquiring an icon of the application or text description of the application; and
displaying the icon of the application or the text description of the application in the shortcut bar, and registering a click action to the icon as an entry of the application.

3. The method according to claim 2, wherein, the step of acquiring an icon of the application or text description of the application comprises:
receiving an operation for setting the shortcut of the application to the notification bar by a user; and
acquiring the icon of the application or the text description of the application corresponding to the shortcut.

4. The method according to claim 1, wherein, before the step of establishing a shortcut bar in a notification bar of a terminal, further comprising:
determining a location of the shortcut bar in the notification bar according to a priority of the shortcut of the application.

5. The method according to claim 1, further comprising:
when at least one of the following cases occurs, canceling the shortcut of the application in the notification bar:
closing a function of setting the shortcut of the application in the notification bar;
deleting the shortcut of the application; and
uninstalling the application corresponding to the shortcut of the application.

6. A device for processing a shortcut of an application, comprising:
an establishment module, configured to: establish a shortcut bar in a notification bar of a terminal; and
a setting module, configured to: set the shortcut of the application in the shortcut bar.

7. The device according to claim 6, wherein, the setting module comprises:
an acquisition module, configured to: acquire an icon of the application or text description of the application; and
a display module, configured to: display the icon of the application or the text description of the application in the shortcut bar, wherein, a click action to the icon is registered as an entry of the application.

8. The device according to claim 7, wherein, the acquisition module is further configured to: receive an operation for adding the shortcut of the application to the notification bar by a user; and acquire the icon of the application or the text description of the application corresponding to the shortcut.

9. The device according to claim 6, wherein, the establishment module further comprises:
a priority storage module, configured to: determine a location of the shortcut bar in the notification bar according to a priority of the shortcut of the application.

10. The device according to claim 6, wherein, cases of canceling the shortcut of the application in the notification bar comprise at least one of the following:
closing a function of setting the shortcut of the application in the notification bar;
deleting the shortcut of the application; and
uninstalling the application corresponding to the shortcut of the application.

11. The method according to claim 2, wherein, before the step of establishing a shortcut bar in a notification bar of a terminal, further comprising:
determining a location of the shortcut bar in the notification bar according to a priority of the shortcut of the application.

12. The method according to claim 3, wherein, before the step of establishing a shortcut bar in a notification bar of a terminal, further comprising:
determining a location of the shortcut bar in the notification bar according to a priority of the shortcut of the application.

13. The method according to claim 2, further comprising:
when at least one of the following cases occurs, canceling the shortcut of the application in the notification bar:
closing a function of setting the shortcut of the application in the notification bar;
deleting the shortcut of the application; and
uninstalling the application corresponding to the shortcut of the application.

14. The method according to claim 3, further comprising:
when at least one of the following cases occurs, canceling the shortcut of the application in the notification bar:
closing a function of setting the shortcut of the application in the notification bar;
deleting the shortcut of the application; and
uninstalling the application corresponding to the shortcut of the application.

15. The device according to claim 7, wherein, the establishment module further comprises:
a priority storage module, configured to: determine a location of the shortcut bar in the notification bar according to a priority of the shortcut of the application.

16. The device according to claim 8, wherein, the establishment module further comprises:
a priority storage module, configured to: determine a location of the shortcut bar in the notification bar according to a priority of the shortcut of the application.

17. The device according to claim 7, wherein, cases of canceling the shortcut of the application in the notification bar comprise at least one of the following:
closing a function of setting the shortcut of the application in the notification bar;
deleting the shortcut of the application; and
uninstalling the application corresponding to the shortcut of the application.

18. The device according to claim 8, wherein, cases of canceling the shortcut of the application in the notification bar comprise at least one of the following:
closing a function of setting the shortcut of the application in the notification bar;
deleting the shortcut of the application; and
uninstalling the application corresponding to the shortcut of the application.
